(19) United States
(12) Patent Application Publication
(10) Pub. No.: US 2026/0336511 A1
(43) Pub. Date: Oct. 29, 2026

(54) METHOD FOR ILLUMINATING AN AREA SURROUNDING A MOTOR VEHICLE AND AN ADDITIONAL VEHICLE, AND MOTOR VEHICLE

(71) Applicant: AUDI AG, Ingolstadt (DE)

(72) Inventors: Valentin SCHMIDT, Neuburg a.d. Donau (DE); Tilman ARMBRUSTER, Ingolstadt (DE); Marcel DEBELEC, Ingolstadt (DE)

(21) Appl. No.: 19/119,653

(22) PCT Filed: Oct. 6, 2023
(86) PCT No.: PCT/EP2023/077766

§ 371 Date: Apr. 9, 2025

(30) Foreign Application Priority Data
Oct. 14, 2022 (DE) 10 2022 126 939.6

(51) Int. Cl. B60Q 1/14; H05B 47/115

(52) U.S. Cl. CPC B60Q 1/143; H05B 47/115; B60Q 2300/054; B60Q 2300/112; B60Q 2300/114; B60Q 2300/122; B60Q 2300/33; B60Q 2300/40

(57) ABSTRACT

A method for illuminating an area in which a motor vehicle including a motor vehicle lighting device is located, a motor vehicle light distribution being variable with regard to an emission-angle-dependent brightness being generated by the motor vehicle lighting device, an additional vehicle light distribution being generated by an additional vehicle lighting device of an additional vehicle located in the area, an item of illumination information that relates to the additional vehicle light distribution being transmitted from the additional vehicle to the motor vehicle, an overall illumination pattern in the area being determined based on the item of illumination information, and the motor vehicle light distribution and/or the additional vehicle light distribution being modified such that a motor vehicle illumination pattern generated by the motor vehicle light distribution and an additional vehicle illumination pattern generated by the additional vehicle light distribution produce the overall illumination pattern.

### BACKGROUND

### Technical Field

The present disclosure relates to a method for illuminating a surrounding area, in which at least one motor vehicle comprising at least one motor vehicle lighting device is located, wherein a motor vehicle light distribution, which can be varied with regard to an emission-angle-dependent brightness, can be generated by way of the motor vehicle lighting device, wherein an additional vehicle light distribution can be generated by way of at least one additional vehicle lighting device of at least one additional vehicle located in the surrounding area.

### Description of the Related Art

Lighting devices in vehicles typically comprise front, rear and/or side lights and on the one hand serve the purpose of illuminating a surrounding area of the respective vehicle for the driver and, on the other hand, to make an output of information for other road users possible, for example, via a flasher that implements a direction indicator, or via a rear light, in particular a white one, by way of which it is indicated that reverse gear is currently engaged.

In the state of the art, it has been recognized that it can be expedient to use lighting devices of a plurality of vehicles simultaneously or in a complementary manner in order to implement the most advantageous overall illumination situation possible in the area surrounding a vehicle. It is, moreover, known from the state of the art to adjust the emission-angle-dependent brightness of vehicles depending on items of information concerning the surrounding area.

For example, DE 10 2012 016 782 A1 discloses that items of information relating to a traffic situation in an area surrounding a motor vehicle is gathered, for example, by way of a camera module by way of which a light distribution in the area surrounding the motor vehicle is gathered. In particular, it may also be provided that messages from other road users regarding these items of information are used by way of a car-2-car interface. Depending on this, a light pattern generated by the headlight system of the motor vehicle is determined.

The establishment of a communication link between a plurality of vehicles is known from DE 10 2019 002 262 A1, wherein one of the vehicles informs the respective other vehicles with regard to the light components to be generated in an overall light distribution. In this manner, an optimum illumination of the area surrounding these vehicles is implemented, in which, in particular, double illumination is avoided.

DE 10 2018 122 240 A1 discloses a method for controlling a motor vehicle headlight of a vehicle in a vehicle convoy, in which a front vehicle gathers data relating to the surroundings by way of a sensor system, wherein the data is transmitted to the rear vehicle. The illumination generated by the rear vehicle is adapted as a function of this data in such a way that the detection area of the sensor system is completely and sufficiently illuminated.

### BRIEF SUMMARY

The present disclosure sets itself the task of implementing an improved concept with regard to the illumination of a surrounding area in which a plurality of vehicles are located.

The task is solved according to the disclosure with a method of the aforementioned type in that at least one item of illumination information, which relates to the currently and/or prospectively generated and/or generatable additional vehicle light distribution, is transmitted from the additional vehicle to the motor vehicle via a communication link formed between the motor vehicle and the additional vehicle, wherein an overall illumination pattern in the surrounding area is determined on the basis of the item of illumination information and in particular on the part of the motor vehicle, and the motor vehicle light distribution and/or the additional vehicle light distribution are/is modified in such a way that the motor vehicle illumination pattern generated by way of the motor vehicle light distribution and the additional vehicle illumination pattern generated by way of the additional vehicle light distribution produce the overall illumination pattern.

In the method according to the disclosure, instead of or in addition to a sensory acquisition of data, in particular of image data relating to the surrounding area, it is provided that the item of illumination information relating to the illumination generated or prospectively generated by the additional vehicle, which is to say, relating to the current or prospectively generated additional vehicle light distribution, is transmitted to the motor vehicle via the communication link. The operation of the lighting devices, in particular the motor vehicle lighting device is controlled on the basis of the item of illumination information. The corresponding information or alternatively database for generating the overall illumination pattern is therefore optimized in such a way that a comparatively complex acquisition and processing of, for example, image data or the like, which is used to determine items of information on the additional vehicle light distribution, for example, by way of image evaluation software, is no longer imperatively necessary. This advantage becomes particularly evident in the case where the item of illumination information is an, in particular standardized, identifier of an additional vehicle light distribution. Details or alternatively items of information relating to the additional vehicle light distribution can then be determined by the motor vehicle by retrieving items of information which are stored, for example, in a database on the motor vehicle side and which is assigned to this light distribution.

Just like, in particular, the additional vehicle lighting device, the motor vehicle lighting device can comprise a light-emitting diode matrix headlight and a control unit set up to control the light-emitting diode matrix headlight. The light-emitting diode matrix headlight can be used, for example, to generate projections onto a surface in the surrounding area, for example, onto the roadway or onto a house wall. These projections can be used to output animations, in particular moving animations, and/or text and/or symbols. These headlights can be used to generate specific front signatures, which is to say, illuminated areas of the headlight with a specific, predefined geometric shape.

The “surrounding area” is to be understood as a common surrounding area of the motor vehicle and the additional vehicle, which comprises at least one partial area that can be illuminated by way of the motor vehicle lighting device and by way of the additional vehicle lighting device. The surrounding area can be an area of an intersection or of a road, wherein the motor vehicle and the additional vehicle are located in the respective intersection or road.

The term “light distribution” refers to the relationship between the brightness of the light emitted by the respective lighting device and the associated emission angle from the respective vehicle or from the respective lighting device. The motor vehicle or the additional vehicle or the respective lighting device serves as the reference system for the light distribution. The light distribution can, for example, be completely described or specified using a set of a plurality of triplets of numbers, wherein the triplet of numbers comprises a first number value relating to a horizontal emission angle, a second number value relating to a vertical emission angle, and a third number value relating to the associated brightness.

The term “illumination pattern” refers to the relationship between the brightness caused by the light distribution or light distributions at a point in the surrounding area and the respective position of this point. The position is described using a coordinate system set to the location or surrounding area. The surrounding area therefore serves as the reference system for the illumination pattern. The illumination pattern can be completely described or specified, for example, using a set of a plurality of quadruplets of numbers, wherein the quadruplet of numbers comprises three number values relating to the location coordinates of the point, for example Cartesian coordinates, and a further number value relating to the associated brightness.

With regard to the communication link, a direct communication between the motor vehicle and the additional vehicle can be provided. A so-called car-2-car connection is conceivable, in which items of information can be transmitted, for example, via radio, in particular using a WLAN. Standards such as DSRC, UMTS, LTE, 5G or the like are also conceivable. An indirect communication link between the motor vehicle and the additional vehicle, which is formed via a so-called car-2-X connection, is also conceivable. The communication link can be provided for unidirectional or bidirectional data transmission.

With regard to the overall illumination pattern, it is, in particular, provided that this provides optimum illumination of the surrounding area from the perspective of the occupants of the motor vehicle and the additional vehicle. In this manner, it is, for example, conceivable that the extension of the overall illumination pattern is greater than the respective extension of the motor vehicle illumination pattern and the additional vehicle illumination pattern, so that these two illumination patterns complement each other advantageously.

In the method according to the disclosure, it may be provided that at least one of the light distributions is changed in such a way that the motor vehicle illumination pattern and additional vehicle illumination pattern, which result in the overall illumination pattern, are separate. In this embodiment, it is provided that is there no illumination by the motor vehicle lighting device and the additional vehicle lighting device at any point in the surrounding area. In so doing, this prevents, on one hand, individual areas of the surrounding area from being illuminated twice, resulting in an overall brightness that could dazzle the occupants of the motor vehicle and the additional vehicle. On the other hand, energy can be saved by avoiding double lighting.

According to the disclosure, it may be provided that the item of illumination information relates to an emission-angle-dependent brightness of the additional vehicle light distribution. The item of illumination information can, as already mentioned, be present as an, in particular standardized, identifier and/or be the set of a plurality of triplets of numbers for describing this light distribution.

In addition or alternatively, the item of illumination information can relate to an extension and/or a brightness distribution of the additional vehicle illumination pattern. In this manner, for example, the additional vehicle can determine the set of a plurality of quadruplets of numbers mentioned above and transmit it to the motor vehicle as the item of illumination information.

In addition or alternatively, it can be provided according to the disclosure that the motor vehicle and the additional vehicle are each provided with at least one activatable light distribution that can only be generated when the vehicle has been activated. The motor vehicle lighting device and the additional vehicle lighting device are therefore fundamentally configured and set up to generate at least one activatable light distribution. In addition, the control unit of the respective lighting device or alternatively one control device of the motor vehicle or respectively of the additional vehicle is set up to control the respective headlight or the respective lighting device to generate different light distributions and thus light functions in such a way that the activatable light distributions can only be realized upon successful activation and the realization of these light distributions is prevented or suppressed when activation has not occurred. The corresponding activation is, for example, linked to the payment of a corresponding fee. Such concepts are typically referred to as “Functions on Demand” (FoD).

In the context of this embodiment, it can be provided according to the disclosure that the item of illumination information relates to at least one additional vehicle light distribution that is enabled and/or not enabled by the additional vehicle, wherein the overall illumination pattern corresponds, on the one hand, to an additional vehicle light distribution that is enabled by the motor vehicle and, on the other side, to an additional vehicle light distribution that is not enabled by the additional vehicle. In this embodiment, a transfer, in particular a temporary transfer, of corresponding function activations to the additional vehicle takes place, so that its occupant can also enjoy the advantages of the activation.

It is conceivable that the additional vehicle light distribution is static with regard to the emission-angle-dependent brightness, wherein only the motor vehicle light distribution is changed to generate the overall illumination pattern. The term “static” means that the additional vehicle lighting device, which is switched on and in particular operated in a specific operating mode, such as a high beam mode, a parking mode, a daytime running mode or a low beam mode, has a constant brightness for each emission angle. Corresponding examples of additional vehicles are older model motor vehicles whose additional vehicle lighting devices can only be used to implement the aforementioned illumination modes. A bicycle is conceivable as an example for a corresponding additional vehicle, the light distribution of which can at best be changed by moving a handlebar to which a bicycle light is attached. As long as the additional vehicle light distribution is static, it is ultimately integrated, “as is,” into the overall illumination pattern.

It is conceivable that the additional vehicle light distribution can be changed with regard to the emission-angle-dependent brightness, wherein the motor vehicle light distribution and the additional vehicle light distribution are changed to generate the overall illumination pattern. In this embodiment, both light distributions are adjusted to generate the overall illumination pattern. Changeable parameters relating to the respective light distribution are hereby determined, in particular, by the respective vehicle. It is also conceivable that the changeable parameters relating to both light distributions are determined by the respective vehicle and, for example, transmitted to the additional vehicle via the communication link.

According to the disclosure, it is optionally provided that at least one additional vehicle item of information is gathered, which relates to the manufacturer of the additional vehicle. The additional vehicle item of information can relate to the brand of the additional vehicle. It is also conceivable that the additional vehicle item of information relates to the additional vehicle technology set up for the operation of the additional vehicle lighting device by the additional vehicle. The additional vehicle item of information may relate to an item of information as to whether the additional vehicle lighting device is designed as a light-emitting diode matrix headlight or comprises such a headlight.

With regard to the additional vehicle item of information, it is provided that the determination of the overall illumination pattern and the change of the motor vehicle light distribution and/or additional vehicle light distribution only occurs if a generation condition is fulfilled, which is then fulfilled when the gathered additional vehicle item of information indicates that the manufacturer of the additional vehicle is comprised in a predefined list of manufacturers and/or if the additional vehicle technology has a predefined minimum standard.

It is therefore possible to verify whether the manufacturer of the additional vehicle is the same manufacturer as that of the motor vehicle, and the method according to the disclosure is only carried out or continued in such a case. In this case, the list of manufacturers comprises only a single manufacturer. The list of manufacturers may also comprise those automobile manufacturers that belong to the same group or group family as the motor vehicle. The list of manufacturers is preferably stored by the motor vehicle.

In addition or alternatively, a verification can be carried out to this effect to determine whether the technological equipment with regard to the lighting devices of the motor vehicle and the additional vehicle are identical or at least comparable. In particular, since the technologies relating to the hardware of lighting devices are often standardized, this verification can be carried out without excessive effort.

At least one piece of additional vehicle driving operation item of information can be gathered, in particular by the motor vehicle, wherein the determination of the overall illumination pattern and the change in the motor vehicle light distribution and/or the additional vehicle light distribution takes place as a function of the additional vehicle driving operation item of information. In this embodiment, the overall illumination pattern is determined on a situation-specific basis using circumstances relating to the additional vehicle. The additional vehicle driving operation item of information can be gathered by the additional vehicle or be available and transmitted to the motor vehicle via the communication link.

The additional vehicle driving operation item of information can, in an exemplary manner, relate to a position or a speed or an acceleration or an intended direction of travel of the additional vehicle. The position can be appropriately used to determine the overall illumination pattern in such a way that an region of the surrounding area located behind the additional vehicle is excluded from the illumination by way of the overall illumination pattern. The speed or alternatively the acceleration can be used to determine the overall illumination pattern in such a way that the greater the speed or alternatively acceleration of the additional vehicle, the greater the region of the surrounding area illuminated by the overall illumination pattern and located in front of the additional vehicle. The intended direction of travel of the additional vehicle can be used to determine the overall illumination pattern in such a way that, if the additional vehicle is about to turn or carry out a lane change, in addition to the illumination of the road or lane of travel in which the additional vehicle is currently located, the road or lane of travel on which the additional vehicle will prospectively be traveling is illuminated.

In particular, in an analogous manner, it is conceivable that at least one motor vehicle driving operation item of information is gathered by the motor vehicle, wherein the determination of the overall illumination pattern and the change in the motor vehicle light distribution and/or the additional vehicle light distribution occurs as a function of the additional vehicle driving operation item of information. In this embodiment, the overall illumination pattern is determined in a situation-specific manner on the basis of circumstances relating to the motor vehicle.

The motor vehicle driving operation item of information can relate to a position or a speed or an acceleration or a steering angle or navigation item of information or a gear lever position or an intended direction of travel or a brightness of the surrounding area. The aspects elucidated in connection with the additional vehicle driving operation item of information apply in an equal manner here. It is, in particular, envisaged that the intended direction of travel is determined using the steering angle and/or the navigation item of information, and/or that the gear lever position, which describes the gear currently engaged on the motor vehicle, is used in addition to the information relating to the speed or acceleration. The brightness of the surrounding area can be used to determine the overall illumination pattern in such a way that the lower the brightness of the surrounding area, the higher the brightness of the overall illumination pattern. In this manner, for example, the brightness generated by the lighting devices can accordingly be increased at night, especially if there is no road lighting.

According to the disclosure, it may preferably be provided that the determination of the overall illumination pattern and change of the motor vehicle light distribution and/or the additional vehicle light distribution only occurs if an initiation condition is fulfilled, which is then fulfilled when determined or gathered relative position information relating to the relative position between the additional motor vehicle and the motor vehicle indicates that the generation of the overall illumination pattern is possible. The relative position information can be gathered by way of corresponding sensors of the motor vehicle, in particular, a camera or a radar sensor. Alternatively, it is conceivable to determine the relative position on the basis of the driving operation items of information relating to the respective vehicle position.

In this manner, for example, situations are conceivable in which, notwithstanding the communication link between the motor vehicle and the additional vehicle is formed because they are close enough to each other, it is still not possible to generate the overall illumination pattern, for example, if the motor vehicle and the additional vehicle are located in different side roads. Specifically, it can therefore be verified whether the surrounding area of the motor vehicle and the surrounding area of the additional vehicle comprise at least one common sub-area or are identical, wherein the overall illumination pattern can be generated in the common sub-area or in the identical surrounding area.

In the context of the present disclosure, it is conceivable that the determination of the overall illumination pattern and the change of the motor vehicle light distribution and/or the additional vehicle light distribution only occurs if a release condition is fulfilled, which is then fulfilled when there exists a release signal generated by an occupant of the motor vehicle by way of at least one interface with the occupant of the motor vehicle. The occupant of the motor vehicle is thus given the choice of whether they wish to carry out the method according to the disclosure, which is to say, the determination and generation of the overall illumination pattern. In particular, the occupant can decide whether or not they wish to share the activation of a light distribution that they have enabled with an occupant of the additional vehicle. The interface with the occupant is an input device of the motor vehicle, in particular, an input and output device such as a touchscreen.

It is conceivable that a request information is output to the occupant of the motor vehicle by way of the, or by at least one further, interface with the occupant automatically and that the release signal can be generated by the occupant of the motor vehicle when the request information is output. In concrete terms, it is therefore conceivable that, for example, when the initiation condition is fulfilled, a message is output to the occupant of the motor vehicle by way of the interface with the occupant, which informs them that it is possible to share the activatable light distribution with another road user, which is to say, the additional vehicle. The release signal can then be generated by the occupant of the motor vehicle by tapping a confirmation button displayed on the touchscreen.

Instead of the automatic output of the request information, it may be provided that the request information is output to the occupant of the motor vehicle by way of the at least one additional interface with the occupant when a request signal generated by an occupant of the additional vehicle is present and the release signal can be generated by the occupant of the motor vehicle when the request information is output. In this way, the occupant of the additional vehicle can be given information as a request signal by way of a corresponding interface with the occupant of the additional vehicle, which interface can be an input and output device such as a touchscreen, to the effect that another road user, namely the motor vehicle, is located in the surrounding area, wherein as a result, for example, a corresponding activation of light functions not enabled by the additional vehicle is, in principle, possible. The occupant of the additional vehicle can tap a corresponding request button to generate the request signal, which causes the request information to be output to the motor vehicle, which the occupant there can accept or not accept, as described above.

According to the disclosure, it is preferably provided that at least one light function can be realized by way of the light distribution. In this context, it is, in particular, provided that the light distribution is an activatable light distribution, by way of which an activatable light function is realized as an FoD. The light function can be a dipped beam function and/or a high beam function and/or a cornering light function and/or a traffic light function and/or a lane marking light function and/or a lane change light function and/or an orientation light function and/or a gamification function. In particular, a plurality of the aforementioned light functions can also be provided, wherein only a part of these functions are activatable and the other part, such as, for example, the dipped beam function and the high beam function, is always enabled. The lighting device used in the context of the light function can therefore be used to create an adaptive light distribution that goes beyond simply illuminating the surrounding area.

In this manner, for example by way of the cornering light function, for example in the area of an intersection, a cross road into which the motor vehicle or the additional vehicle will turn can be specifically illuminated. The traffic light function can be used to illuminate the entire area of an intersection where, for example, depending on the design of the intersection, two roads intersect or where at least one other road branches off from a road. The lane marking light function is used to specifically illuminate individual lanes of travel in the event that a plurality of lanes of travel are provided along the road currently being driven on, such as, for example, the lane of travel currently being travelled on and/or a lane of travel that is adjacent thereto, to which the motor vehicle or the additional vehicle is about to turn into. Using the lane change light function, an arrow is projected onto the road surface in a multi-lane road when the respective vehicle is about to make a corresponding lane change. The orientation light function is used to project directional arrows onto the road surface, in particular on the basis of information received from the navigation system, so that the occupants of the vehicle can find their way around more easily. In the context of the gamification function, it is conceivable that projections for generating the representation of the game surface of a video game are projected onto a wall and/or the ground in front of the motor vehicle and the additional vehicle, in particular by way of the lighting devices configured as light-emitting diode matrix headlights. This allows the occupants to bridge time, for example during a charging process of the motor vehicle or additional vehicle designed as a hybrid or electric vehicle. The game control provided in this context can take place by way of the personal mobile devices of the occupants, in particular smartphones, so that the lighting devices constitute projectors or beamers for the video game. Apart from the display of video games, it is also conceivable to display films or the like.

In the context of the method according to the disclosure, it is also, in particular, conceivable that a plurality of additional vehicles are integrated in addition to the motor vehicle when the method is carried out. All aspects of the method according to the disclosure elucidated so far can also be applied to this situation. In particular, it may be provided that the overall illumination pattern results from the motor vehicle illumination pattern and a plurality of additional vehicle illumination patterns.

The present disclosure, moreover, relates to a motor vehicle comprising at least one motor vehicle lighting device, by way of which a motor vehicle light distribution, which can be changed with regard to an emission-angle-dependent brightness, can be generated. The motor vehicle according to the disclosure is characterized by a communication device, by way of which a communication link can be formed between the motor vehicle and the at least one additional vehicle with at least one additional vehicle lighting device and via which at least one item of illumination information, which relates to an additional vehicle light distribution which is currently generated and/or can prospectively be generated by way of the additional vehicle lighting device, can be transmitted from the additional vehicle to the motor vehicle, and a control device which is set up to use the item of illumination information to determine an overall illumination pattern in a surrounding area in which the motor vehicle and the additional vehicle are located and to generate a control signal which can be transmitted to the motor vehicle lighting device and by way of which the motor vehicle light distribution is changed in such a way that the motor vehicle light distribution and the additional vehicle light distribution produce the overall illumination pattern.

All the advantages and features elucidated in connection with the method according to the disclosure can be transferred to the motor vehicle according to the disclosure and vice versa. Thus, in the context of the execution of the method according to the disclosure, it can also be provided that the at least one additional vehicle is likewise a motor vehicle according to the disclosure.

### BRIEF DESCRIPTION OF THE SEVERAL VIEWS OF THE DRAWINGS

Further advantages and details of the disclosure are shown in the following embodiments and in the figures. Wherein, in a schematic manner:

FIG. 1 shows a schematic diagram of a motor vehicle according to the disclosure, according to one embodiment,

FIG. 2 shows a view of an intersection with a traffic situation in which the method according to the disclosure is executed according to a first embodiment example and in which the motor vehicle of FIG. 1 is involved,

FIG. 3 shows a flow chart illustrating the first embodiment example of the method according to the disclosure,

FIG. 4 shows a view of a multi-lane road with a traffic situation in which the method according to the disclosure is executed according to a second embodiment example and in which the motor vehicle of FIG. 1 is involved, wherein this method is also executed using the flow diagram shown in FIG. 3, and

FIG. 5 shows a symbolic representation of an item of illumination information as it is transmitted as part of the method elucidated with reference to FIG. 3 and FIG. 4.

### DETAILED DESCRIPTION

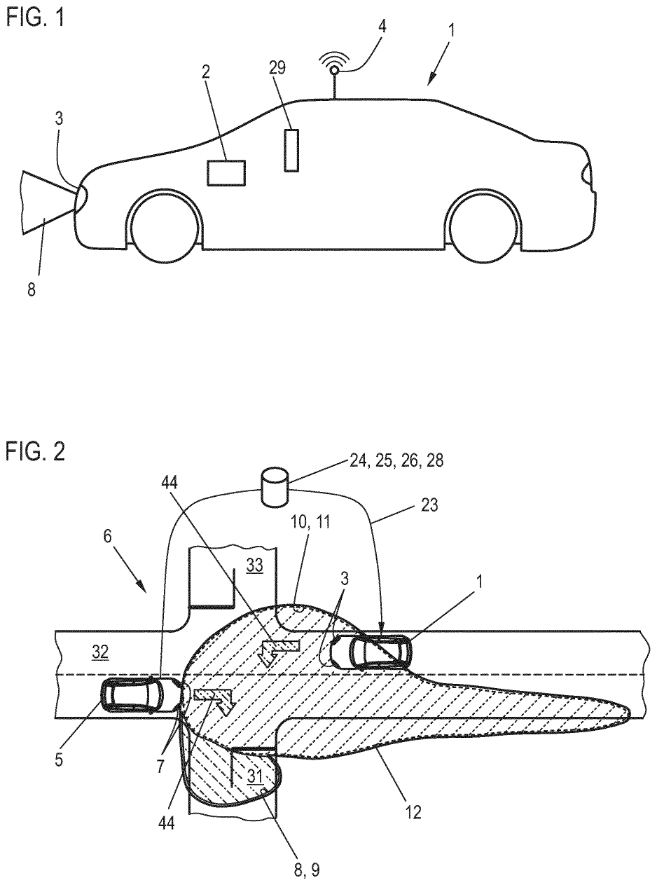

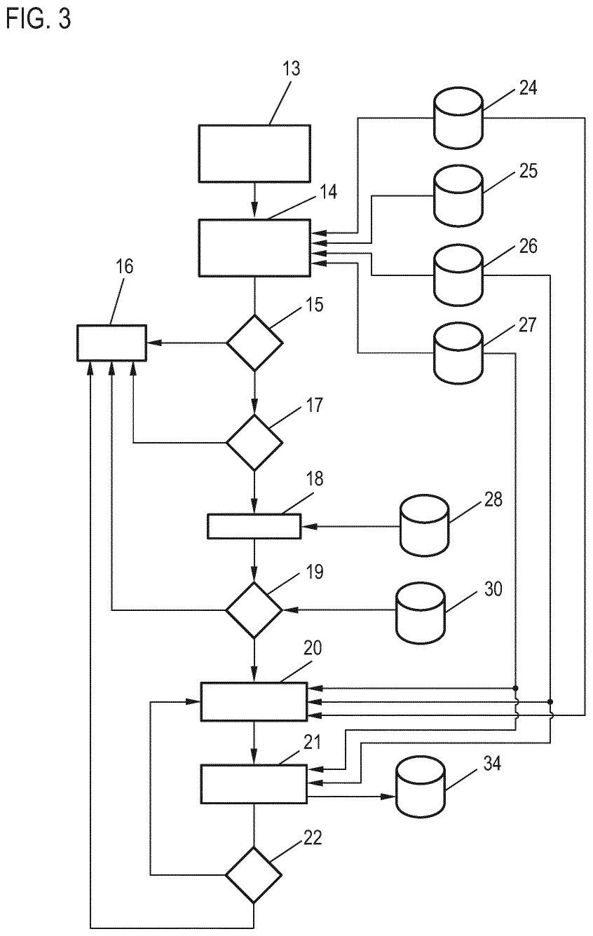

First of all, a first embodiment example of the method according to the disclosure is elucidated, wherein a participating motor vehicle 1 according to the disclosure according to an embodiment example in FIG. 1 is shown. FIG. 2 shows an exemplary situation in which the method, the details of which are elucidated with reference to the flow chart shown in FIG. 3, is shown. To execute this method, the motor vehicle 1 comprises a control device 2, a motor vehicle lighting device 3, which can be controlled by way of the control device 2, and a communication device 4. An additional vehicle 5 is also involved in executing the method, wherein the motor vehicle 1 and the additional vehicle 5 are located in a common surrounding area 6, in this case an intersection.

With regard to the motor vehicle lighting device 3, it is provided that this is a light-emitting diode matrix headlight, by way of which the light can be adaptively generated and emitted. The additional vehicle 5 comprises an additional vehicle lighting device 7, which can likewise be a light-emitting diode matrix headlight, but in the present case is configured as a headlight comprising a plurality of light bulbs, by way of which a low beam and a high beam can be generated.

The motor vehicle lighting device 3 can be used to generate a motor vehicle light distribution 8 that is variable in terms of emission-angle-dependent brightness, by way of which a motor vehicle illumination pattern 9 in the surrounding area 6 can be generated. With reference to FIG. 2, the motor vehicle illumination pattern 9 is indicated by the dotted line and the dashed hatching. The additional vehicle lighting device 3 can be used to generate an additional vehicle light distribution 10, by way of which an additional vehicle illumination pattern 11 can be generated in the surrounding area 6. With reference to FIG. 2, the additional vehicle illumination pattern 11 is indicated by the dashed line and the dashed hatching and currently realizes a dipped beam. The motor vehicle illumination pattern 9 and the additional vehicle illumination pattern 11 result in an overall illumination pattern 12, which is indicated in FIG. 2 by the solid lines and will be discussed in detail below.

The steps of the first embodiment example of the method according to the disclosure, comprising steps 13 to 22, are elucidated below with reference to FIG. 3. In so doing, the control device 2 is configured to execute the method steps elucidated below. For example, the control device 2 include a processor and a memory storing instructions that, when executed by the processor, cause the control device 2 to perform the acts described herein. For this purpose, the control device 2 is connected to the corresponding components of the motor vehicle 1.

In the first step of the method, a communication link 23 is established between the motor vehicle 1 and the additional vehicle 5. This is possible, in particular, because the motor vehicle 1 and the additional vehicle 5 are in close proximity to each other, namely at the intersection shown in FIG. 2. For the formation of the communication link 23, the communication device 4 of the motor vehicle 1 and a further communication device of the additional vehicle 5, which is not shown in detail in the figures, are provided. The communication link 23 is realized in an exemplary manner by way of a car-2-car connection, but can likewise also be formed by way of an indirect connection, such as a car-2-X connection.

The item of illumination information 24 is transmitted from the additional vehicle 5 to the motor vehicle 1 by way of the communication link 23, wherein the item of illumination information 24 relates to the additional vehicle light distribution 10 generated currently and prospectively. In a concrete manner, the item of illumination information 24 relates to information regarding an emission-angle-dependent brightness of the additional vehicle light distribution 10, wherein this can also relate to an extension or a distribution of the brightness of the additional vehicle illumination pattern 11. The item of illumination information 24 specifically comprises the “low beam” information together with standardization information specifying the additional vehicle light distribution 10.

In the context of the second step 14, additional vehicle item of information 25, which is available from the additional vehicle 5, is transmitted from the additional vehicle 5 to the motor vehicle 2 by way of the communication link 23. The additional vehicle item of information 25 relates to the manufacturer of the additional vehicle 5.

In the context of the second step 14, additional vehicle driving operation items of information 26 is moreover transmitted from the additional vehicle 5 to the motor vehicle 1 by way of the communication link 23. The respective additional vehicle driving operation items of information 26 relates respectively to or alternatively describes a current position, a current speed, a current acceleration or an intended direction of travel of the additional vehicle 5. To gather the additional vehicle driving operation item of information 26 relating to the position or to the speed or to the acceleration of the additional vehicle 5, it may also be provided that a sensor device of the motor vehicle 1, such as a camera and/or radar sensor, which is not shown in more detail in the figure, is used. The additional vehicle driving operation item of information 26 relating to the intended direction of travel of the additional vehicle 5 indicates that the additional vehicle 5 is about to turn right. This information can be provided by the additional vehicle 5 as part of a corresponding navigation system or can be generated on the basis of an activated blinker.

In the context of the second step 14 of the method, motor vehicle driving operation items of information 27 are further gathered by the motor vehicle 1. These items of information may be present in a vehicle control system and/or a navigation system of the motor vehicle 1 and/or may be gathered by sensors. The respective motor vehicle driving operation items of information 27 respectively relate to or alternatively describes a position, a speed or an acceleration of the motor vehicle 1. These items of information, moreover, respectively relate to or alternatively describe a current steering angle, navigation information relating to a planned route of the motor vehicle 1, a gear lever position relating to a currently engaged gear, an intended direction of travel, which can be determined, for example, using an activated blinker and/or using the navigation information, or a surrounding area brightness currently present in the surrounding area 6.

In the third step 15 of the method, the fulfillment of an initiation condition is verified, wherein if this condition is not fulfilled, the method is terminated in step 16. In the context of the verification of the initiation condition, a relative position between the vehicles 1, 5 is first determined using the driving operation items of information 26, 27 relating to the motor vehicle 1 and the additional vehicle 5. If this result shows that the vehicles 1, 5 are located in the or one common surrounding area 6, which can be at least partially illuminated by both the motor vehicle lighting device 3 and the additional vehicle lighting device 7, in which case, the method is then continued in the next step 17. This is the case here, inasmuch as the vehicles 1 and 5 are located in the common surrounding area 6, namely in the area of the intersection shown in FIG. 2.

In the next step 17 of the method, a generation condition is verified; if this condition is not met, the method is terminated in step 16. In the context of the verification of the generation condition, the additional vehicle item of information 26 is used by the motor vehicle 1 for verification whether the manufacturer of the additional vehicle 5 is included among a predefined list of manufacturers stored by the motor vehicle 1. In this manner, the list of manufacturers comprises, for example, those automobile manufacturers or brands that belong to the same group as the motor vehicle 1. The list of manufacturers may, however, also only include a single manufacturer, namely the manufacturer of the motor vehicle 1, so that the method according to the disclosure only continues if the vehicles 1 and 5 originate from the same manufacturer. This is assumed in the present embodiment example, so that the generation condition is fulfilled and the method is therefore continued in the next step 18.

In the next step 18 of the method, the occupant of the additional vehicle 5 is provided with an item of information by way of an interface with the occupant, which is not shown in detail in the figures and which can be an input and output device such as a touchscreen, indicating that it is, in principle, possible to generate the overall illumination pattern 12 together with the motor vehicle 1. For this purpose, the text “Shared illumination with another vehicle possible. Send request?” is displayed. The occupant of the additional vehicle 5 can then tap a corresponding request button to generate a corresponding request signal 28, which is transmitted to the motor vehicle 1 by way of the communication link 23. If this has been done, the occupant of the motor vehicle 1 is provided with request information by way of an interface with the occupant 29 of the motor vehicle 1, which can be an input and output device such as a touchscreen, as to whether the occupant wishes the overall illumination pattern 12 to be generated. This can take place, for example, by outputting the text “Other road user suggests shared illumination. Agree?”. The occupant of the motor vehicle 1 can then bring about a corresponding release signal 30 to be generated by tapping a corresponding confirmation button.

In the context of the next step 19, a verification of the release condition is executed, which is then fulfilled when the release signal 30 that can be generated by the occupant of the motor vehicle 1 is present. If the release condition is not fulfilled, the method is terminated in step 16. If the release condition is fulfilled, the method is continued in the next step 20. It should also additionally be mentioned with regard to step 18, that the step may solely be provided as an option, since the request to the user of the motor vehicle 1 regarding the generation of the release signal can also be made automatically and independently of the presence of the request signal 28.

In the next step 20 of the method, the motor vehicle 1, on its side, executes the determination of the overall illumination pattern 12 on the basis of the lighting information 24 and the driving operation items of information 26, 27. This determination is executed in such a way that the overall illumination pattern 12 realizes an illumination in the surrounding area 6 that is advantageous and expedient from the perspective of the occupants of both vehicles 1, 5. Details in this regard are elucidated below.

The additional vehicle light distribution 10 is therefore static with regard to the emission-angle-dependent brightness of the additional vehicle 5. This means that it is not possible to change the additional vehicle light distribution 10 as part of the dipped beam generated by the additional vehicle lighting device 7. This is taken into account when determining the overall illumination pattern 12.

The determination of the overall illumination pattern 12 is executed on the basis of the additional vehicle driving operation items of information 26. These items of information, as already elucidated, indicate that the additional vehicle 5 is about to turn right at the intersection, so that it is provided with the overall illumination pattern 12 that the road 31 leading away from the intersection, and into which the additional vehicle 5 turns starting from the road 32, is additionally illuminated. Since the additional vehicle light distribution 10 is static, this illumination is provided exclusively by changing the motor vehicle light distribution 8. The static additional vehicle light distribution 10 is therefore integrated, as it is, for the generation of the overall illumination pattern 12.

It is moreover provided in connection with the additional vehicle driving operation items of information 26, that the greater the current speed and acceleration of the additional vehicle 5 and the closer it is to the intersection, the greater the brightness generated by the motor vehicle light distribution 8 or the motor vehicle illumination pattern 9 in the corresponding area. If, for example, the additional vehicle 5 is located directly in front of the intersection and is exhibiting a high speed and/or acceleration, the turning of the additional vehicle 5 into road 31 is imminent, so that a correspondingly increased brightness is displayed in the area of road 31, for example to detect any pedestrians or the like.

The determination of the overall illumination pattern 12 in the context of step 20 occurs as a function of the motor vehicle driving operation items of information 27. As a result of the current motor vehicle driving operation items of information 27, namely on the basis of the current position, the current steering angle, the navigation information, and the information relating to the intended direction of travel, this indicates that the motor vehicle 1 in the situation shown in FIG. 2 wishes to turn left, which is to say, likewise coming from road 32 into road 31. If this were to indicate that the motor vehicle 1 wishes to continue straight ahead across the intersection along road 32, then the motor vehicle illumination pattern 9 could additionally also illuminate the corresponding area of road 32 next to and behind the additional vehicle 5. If motor vehicle 1 were to turn right into road 33, then the motor vehicle illumination pattern 9 could also additionally provide illumination of road 33. A cornering light function as well as a traffic light function can therefore be realized by way of the motor vehicle light distribution 8.

With regard to the determination of the overall illumination pattern 12, the motor vehicle driving operation items of information 37 are taken into account insofar as the corresponding brightness is taken into account as a function of the position, the speed, the acceleration and the gear lever position, in a manner analogous to the consideration of the corresponding additional vehicle driving operation items of information 26 with regard to brightness. A further motor vehicle driving operation item of information 27, on which the brightness of the overall illumination pattern 12 or the motor vehicle illumination pattern 9 depends, relates to the current surrounding area brightness in the region of the surrounding area 6. In this manner, it is, for example, expedient if the brightness of the overall illumination pattern 12 generated by the lighting devices 3, 7 is increased at night in the region of the surrounding area 6 when there is no road lighting and therefore less surrounding area brightness.

To determine the overall illumination pattern 12, the items of information available in the driving operation items of information 26, 27 that the vehicle 1, 5 wants to turn into the road 31 is also taken into account. In this manner, the overall illumination pattern 12 provides for two directional arrows 44 to be projected onto the road surface by way of the motor vehicle illumination pattern 9, which arrows indicate the intended direction of travel of the respective vehicle 1, 5. The overall illumination pattern 12 thus implements a so-called orientation light function.

The overall illumination pattern 12 is also determined in such a way that the motor vehicle illumination pattern 9 and the additional vehicle illumination pattern 11 are separate, apart from the directional arrows 44. This avoids areas of double illumination in the surrounding area 6, in particular to save energy and blinding of the occupants.

The control device 2 generates the overall illumination pattern 12 in such a way that the additional vehicle light distribution 10 is determined on the basis of the item of illumination information 24. This is used by the control device 2 to determine the additional vehicle illumination pattern 11 generated by the additional vehicle light distribution 10, which forms part of the overall illumination pattern 12, in particular by performing a coordinate transformation from additional vehicle fixed coordinates to fixed coordinates. The driving operation items of information 26, 27 relating to the positions of the vehicles 1, 5 are used in connection with the coordinate transformation.

In the next step 21 of the method, the control device 2 generates control signals 34, which are transmitted to the motor vehicle lighting device 3 so that the corresponding motor vehicle illumination pattern 9 is generated in accordance with the overall illumination pattern 12. In so doing, the driving operation items of information 26, 27 are constantly updated, wherein the overall illumination pattern 12 is constantly updated as a function of this and corresponding control signals 34 are generated. In connection with the generation of the control signals 34, and on the part of the control device 2, a coordinate transformation is executed going from fixed coordinates, by way of which the illumination pattern 9, 12 is described, to motor vehicle fixed coordinates, by way of which the motor vehicle light distribution 8 is described, this coordinate transformation takes place on the basis of the determined overall illumination pattern 12 or alternatively the part of the determined overall illumination pattern 12 representing the motor vehicle illumination pattern 9.

In the context of the next step 22, the fulfillment of a termination condition is verified. This takes place on a cyclical basis, for example, every 0.1 seconds. The termination condition is fulfilled when the updated relative position information indicates that the vehicles 1, 5 are no longer in the same surrounding area 6. In this case, the method is terminated in step 16. If the termination condition is not fulfilled, the method is continued in step 20 to once again determine the overall illumination pattern 12, taking into account the correspondingly updated items of information 24, 26, 27. The steps 20, 21, 22 are carried out parallel to one another.

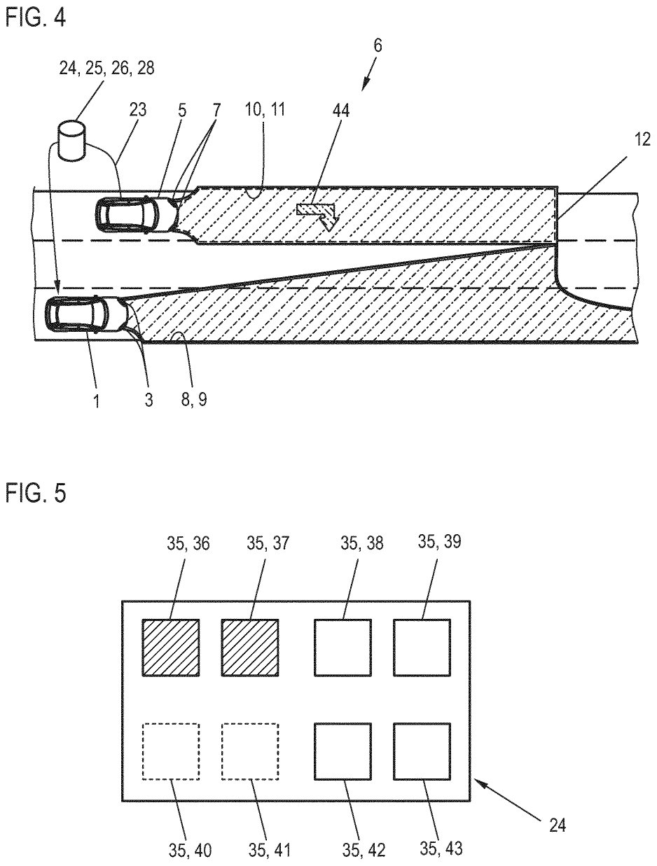

A second embodiment example of the method according to the disclosure is elucidated below with reference to FIG. 4, to which the aspects of the motor vehicle 1 elucidated with reference to FIG. 1 and the procedural steps elucidated with reference to FIG. 3 apply equally, as long as they do not specifically deviate, as described below. It is, in particular, conceivable that features provided in the first embodiment example of the method according to the disclosure can also be provided in the second embodiment example of the method according to the disclosure, as long as this is reasonable and possible, and vice versa.

FIG. 4 shows a traffic situation in which the method according to the disclosure is executed according to the second embodiment, wherein in the following description, reference is again made to the flow diagram of FIG. 3. In the situation shown in FIG. 4, the surrounding area 6 is a three-lane road in which the motor vehicle 1 is driving in the right-hand lane and the additional vehicle 5 is driving in the left-hand lane in the same direction of travel.

In the context of the first step 13 of the method, the communication link 23 is formed between the vehicles 1, 5. In the context of the second step 14, the items of information 24 to 27 are gathered and, if they are available from the additional vehicle 5, transmitted by way of the communication link 23 to the control device 2 of the motor vehicle 1.

The item of illumination information 24 differs here from the embodiment example elucidated with reference to FIG. 2. In this case, it is, for example, provided in both vehicles 1, 5 that light distributions 8, 10 that are activatable by way of the lighting device 3, 7 can only be generated in the case of a previous successful activation. The item of illumination information 24 relates to or describes items of information as to which of the activatable light distributions 10 are enabled in the additional vehicle 5 and which additional vehicle light distribution 10 is currently being generated by the additional vehicle lighting device 7.

To illustrate this point in more detail, reference is made to FIG. 5, which symbolizes the item of illumination information 24. A plurality of activatable light functions 35 can be realized by way of the activatable light distributions 8, 10. A dipped beam function 36 and a high beam function 37 are provided as light functions 35, which are enabled independently of a corresponding activation. A cornering light function 38, an traffic light function 39, a lane marking light function 40, a lane change function 41, an orientation light function 42, and a gamification function 43 are provided as activatable light functions. The functions 35 enabled in the additional vehicle 5 are indicated in FIG. 4 by the boxes with solid lines and the non-enabled light functions 35 are indicated by the boxes with dashed lines. The light functions that are always enabled, which is to say, the dipped beam function 36 and the high beam function 37, are indicated by the boxes with hatched areas. It can be seen that the lane marking light function 40 and the lane change function 41 are not enabled in the additional vehicle 5. This item of illumination information 24, as well as the information that the dipped beam function 36 is currently being realized by way of the additional vehicle lighting device 7, is transmitted via the communication link 23 to the motor vehicle 1, in which all light functions 35 are enabled.

With regard to the additional vehicle item of information 25, it is provided in this embodiment example that this relates to or describes an additional vehicle technology that is provided or respectively set up by the additional vehicle 5 for the operation of the additional vehicle lighting device 7. In the present case, the additional vehicle item of information 25 indicates that the additional vehicle lighting device 7 is a light-emitting diode matrix headlight or comprises such a headlight and that the specific light functions 35 shown in FIG. 5 are, in principle, realizable by way of the additional vehicle 5. During the further execution of the method, this additional vehicle item of information 25 brings about the fulfillment of the verification of the generation condition carried out as part of step 17, since the additional vehicle technology provided in connection with the additional vehicle lighting device 7 has a predefined minimum standard that is required for the further execution of the method.

With regard to the driving operation items of information 26, 27, the aspects elucidated with reference to the first embodiment example of the method according to the disclosure apply equally, wherein reference is made to the corresponding passages of the description. Specifically for the situation shown in FIG. 4, one of the additional vehicle driving operation items of information 26 relates to or respectively describes that a lane change of the additional vehicle 5 from the left-hand to the center lane of travel is imminent. This information is gathered by way of a blinker that is turned on in the additional vehicle 5.

The method elucidated in connection with FIG. 2 and FIG. 3 for verification of the fulfillment of the initiation condition in the context of step 15 applies equally to the method elucidated with reference to FIG. 3 and FIG. 4.

The points elucidated in connection with the generation of the request signal 28 and the release signal 30 in steps 18, 19 apply analogously here, with the exception of that elucidated below. In this manner, in step 18, the text “Temporary activation of the lane marking light function and lane change function possible on request. Send request to additional road users?” is output to the occupant of the additional vehicle 5 by way of the input and output device of the additional vehicle 5. The occupant of the additional vehicle 5 can then tap the request button to generate the request signal 28, which is transmitted to the motor vehicle 1 by way of the communication link 23. If this is done, the request information is output to the occupant of the motor vehicle 1 by way of the interface with the occupant 29 asking whether they also wish the overall illumination pattern 12 to be generated or authorize the corresponding function to be transmitted to the additional vehicle 5. This can be done, for example, by outputting the text “Other road user requests activation of the lane marking light function and lane change function to implement shared illumination. Authorize release?”. The occupant of the motor vehicle 1 can then generate the release signal 30 by tapping the confirmation button. The next step 19, involves verification of the release condition, which is fulfilled when the release signal 30 is present.

The overall illumination pattern 12 is determined during step 20 in such a way that the lane marking light function 40 and lane change light function 41, which are enabled in motor vehicle 1 and not enabled in additional vehicle 5, are realized. As can be seen from FIG. 4, the overall illumination pattern 12 is made up of the additional vehicle illumination pattern 11, which implements the lane marking light function 40, and the motor vehicle illumination pattern 9, which also implements the lane marking light function 40. Specifically, the overall illumination pattern 12 is determined in such a way that the motor vehicle illumination pattern 9 is used to illuminate the right-hand lane of travel and partly the middle lane of travel of the road, and the additional vehicle illumination pattern 11 is used to illuminate the left-hand lane of travel of the road. In so doing, this realizes the lane marking light function 40 for both vehicles 1, 5. The motor vehicle illumination patterns 9 also provide for the generation of a direction arrow 4 projected onto the left lane and indicating the imminent lane change of the additional vehicle 5. This realizes the lane change light function 41 for the additional vehicle 5.

The generation of the corresponding control signals 34 is carried out by the control device 2 of the motor vehicle 1, wherein the control signals 34 relating to the additional vehicle lighting device 7 are transmitted to the additional vehicle 5 by way of the communication link 23. In principle, it is also conceivable that items of information relating to the overall illumination pattern 12 and/or to the additional vehicle illumination pattern 11 determined by the control device 2 of the motor vehicle 1 are transmitted via the communication link 23 provided as a bidirectional connection to a control device of the additional vehicle 5, here corresponding to the control device 2 and not shown in detail in the figures, wherein the control signals 34 provided for the additional vehicle lighting device 7 are generated by the control device of the additional vehicle 5.

With reference to the embodiment example shown in FIG. 4, as regards the additional vehicle 5, it is provided that this is also configured as a motor vehicle according to the disclosure in accordance with an embodiment example, wherein in traffic situations other than those shown, the temporary activation of light functions 35, namely the light functions 42, 43 enabled by the additional vehicle 5, can take place in other vehicles.

In the following, a further embodiment example of the method according to the disclosure is elucidated, for which no figures are shown. In this embodiment example, the vehicles 1, 5 elucidated with reference to FIG. 3 and FIG. 4 are provided, which are positioned next to each other in the corresponding situation and respectively facing a surface such as, for example, a house wall. In a manner analogous to the embodiment example elucidated with reference to FIG. 3 and FIG. 4, the item of illumination information 24 is transmitted with regard to the enabled light functions 35. It is now assumed that the gamification function 43 is enabled on the motor vehicle 1 and not enabled on the additional vehicle 5. After steps 13 to 19 have all been run through and, in particular, all the conditions verified in the process have been met, as regards the gamification function 43 it is provided that an overall illumination pattern 12 is generated by way of the lighting devices 3, 7, which pattern is projected onto the surface. The overall illumination pattern 12 realizes a game surface of a video game that can be controlled by way of mobile end devices, for example, smartphones, of the occupants of the vehicle 1, 5. In this case, the lighting devices 3, 7 act as a kind of projector for the corresponding video game.

Instead of a video game, a movie or similar can also be played.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A method for illuminating a surrounding area in which at least one motor vehicle that includes at least one motor vehicle lighting device is located, wherein a motor vehicle light distribution that is variable with regard to an emission-angle-dependent brightness can be generated by way of the at least one motor vehicle lighting device, wherein an additional vehicle light distribution can be generated by way of at least one additional vehicle lighting device of at least one additional vehicle located in the surrounding area, wherein at least one item of illumination information that relates to a currently and/or prospectively generated and/or generatable additional vehicle light distribution is transmitted from the at least one additional vehicle to the at least one motor vehicle via a communication link formed between the at least one motor vehicle and the at least one additional vehicle, the method comprising:
determining an overall illumination pattern in the surrounding area based on the at least one item of illumination information;
modifying the motor vehicle light distribution and/or the additional vehicle light distribution such that a motor vehicle illumination pattern generated by way of the motor vehicle light distribution and an additional vehicle illumination pattern generated by way of the additional vehicle light distribution produce the overall illumination pattern;
providing each of the at least one motor vehicle and the at least one additional vehicle with at least one activatable light distribution that can only be generated when the at least one motor vehicle has been activated, wherein the at least one item of illumination information relates to at least one additional vehicle light distribution that is enabled and/or not enabled by the at least one additional vehicle, wherein the overall illumination pattern corresponds to an additional vehicle light distribution that is enabled by the at least one motor vehicle, and corresponds to an additional vehicle light distribution that is not enabled by the at least one additional vehicle; and/or
gathering at least one additional vehicle item of information that relates to at least one manufacturer of the at least one additional vehicle or to an additional vehicle technology set up for operation of the at least one additional vehicle lighting device by the at least one additional vehicle, wherein a determination of the overall illumination pattern and a change in the motor vehicle light distribution and/or the additional vehicle light distribution only occurs if a generation condition is fulfilled when the at least one additional vehicle item of information indicates that the at least one manufacturer of the at least one additional vehicle is included in a predefined list of manufacturers and/or if the additional vehicle technology has a predefined minimum standard; and/or
wherein the determining of the overall illumination pattern and the change in the motor vehicle light distribution and/or the additional vehicle light distribution only occurs if a release condition is fulfilled when there exists a release signal generated by an occupant of the at least one motor vehicle by way of at least one interface.

2. The method according to claim 1, wherein the at least one item of illumination information relates to an emission-angle-dependent brightness of the additional vehicle light distribution and/or an extension and/or a brightness distribution of the additional vehicle illumination pattern.

3. The method according to claim 1,
wherein the additional vehicle light distribution is static with regard to the emission-angle-dependent brightness, wherein only the motor vehicle light distribution is changed to generate the overall illumination-pattern, or
wherein the additional vehicle light distribution can be changed with regard to the emission-angle-dependent brightness, and
wherein the method further comprises changing the motor vehicle light distribution and the additional vehicle light distribution to generate the overall illumination pattern.

4. The method according to claim 1, wherein the determining of the overall illumination pattern and the change in the motor vehicle light distribution and/or the additional vehicle light distribution only occurs if the release condition is fulfilled, and
wherein the method further comprises outputting request information to the occupant of the at least one motor vehicle by-means way of the at least one interface, or by at least one further interface, with the occupant automatically or when a request signal generated by an occupant of the at least one additional vehicle is present, and wherein the release signal can be generated by the occupant of the at least one motor vehicle when the request information is output.

5. The method according to claim 1,
wherein at least one light function can be realized by way of the motor vehicle light distribution by way of the activatable light distribution, and
wherein the light function is a dipped beam function and/or a high beam function and/or a cornering light function and/or a traffic light function and/or a lane marking light function and/or a lane change light function and/or an orientation light function and/or a gamification function.

6. The method according to claim 1, further comprising:
gathering at least one additional vehicle driving operation item of information that relates to a position or a speed or an acceleration or an intended direction of travel of the at least one additional vehicle, wherein the determining of the overall illumination pattern and the change in the motor vehicle light distribution and/or the additional vehicle light distribution occurs as a function of the at least one additional vehicle driving operation item of information.

7. The method according to claim 1, further comprising:
gathering at least one motor vehicle driving operation item of information that relates to a position or a speed or an acceleration or a steering angle or navigation item of information or a gear lever position or an intended direction of travel or a brightness of the surrounding area, wherein the determining of the overall illumination pattern and change of the motor vehicle light distribution and/or the additional vehicle light distribution only occurs as a function of the at least one motor vehicle driving operation item of information.

8. The method according to claim 6, wherein the determination of the overall illumination pattern and change of the motor vehicle light distribution and/or the additional vehicle light distribution only occurs if an initiation condition is fulfilled when determined or gathered relative position information relating to a relative position between the at least one additional vehicle and the at least one motor vehicle indicates that generation of the overall illumination pattern is possible.

9. A method for illuminating a surrounding area in which at least one motor vehicle that includes at least one motor vehicle lighting device is located, wherein a motor vehicle light distribution that is variable with regard to an emission-angle-dependent brightness, can be generated by way of the at least one motor vehicle lighting device, wherein an additional vehicle light distribution can be generated by way of at least one additional vehicle lighting device of at least one additional vehicle located in the surrounding area, wherein at least one item of illumination information that relates to a currently and/or prospectively generated and/or generatable additional vehicle light distribution is transmitted from the at least one additional vehicle to the at least one motor vehicle via a communication link formed between the at least one motor vehicle and the at least one additional vehicle, the method comprising:
determining an overall illumination pattern in the surrounding area based on the at least one item of illumination information;
modifying the motor vehicle light distribution and/or the additional vehicle light distribution such that a motor vehicle illumination pattern generated by way of the motor vehicle light distribution and an additional vehicle illumination pattern generated by way of the additional vehicle light distribution produce the overall illumination pattern;
gathering at least one additional vehicle driving operation item of information that relates to a position or a speed or an acceleration or an intended direction of travel of the at least one additional vehicle, wherein the determining of the overall illumination pattern and a change in the motor vehicle light distribution and/or the additional vehicle light distribution occurs as a function of the at least one additional vehicle driving operation item of information;
gathering at least one motor vehicle driving operation item of information that relates to a position or a speed or an acceleration or a steering angle or navigation item of information or a gear lever position or an intended direction of travel or a brightness of the surrounding area, wherein the determining of the overall illumination pattern and the change in the motor vehicle light distribution and/or the additional vehicle light distribution only occurs as a function of the motor vehicle driving operation item of information, wherein the determining of the overall illumination pattern and the change in the motor vehicle light distribution and/or the additional vehicle light distribution only occurs if an initiation condition is fulfilled when determined or gathered relative position information relating to a relative position between the at least one additional vehicle and the at least one motor vehicle indicates that generation of the overall illumination pattern is possible.

10. A motor vehicle, comprising:
at least one motor vehicle lighting device that, in operation, changes a motor vehicle light distribution with regard to an emission-angle-dependent brightness;
a communication device that, in operation, forms a communication link between the motor vehicle and at least one additional vehicle with at least one additional vehicle lighting device and via which at least one item of illumination information that relates to an additional vehicle light distribution which is currently generated and/or can prospectively be generated by way of the at least one additional vehicle lighting device, can be transmitted from the additional vehicle to the motor vehicle; and
a control device that, in operation, uses the at least one item of illumination information to determine an overall illumination pattern in a surrounding area in which the motor vehicle and the additional vehicle are located, and generates a control signal that is transmitted to the motor vehicle lighting device and by way of which the motor vehicle light distribution is changed such that the motor vehicle light distribution and the additional vehicle light distribution produce the overall illumination pattern,
wherein the motor vehicle and the additional vehicle are each provided with at least one activatable light distribution that can only be generated when the vehicle has been activated, wherein the at least one item of illumination information relates to at least one additional vehicle light distribution that is enabled and/or not enabled by the additional vehicle, wherein the control device is configured such that the overall illumination pattern corresponds to an additional vehicle light distribution that is enabled by the motor vehicle, and corresponds to an additional vehicle light distribution that is not enabled by the additional vehicle, and/or,
wherein the control device is configured such that a determination of the overall illumination pattern and a change in the motor vehicle light distribution and/or the additional vehicle light distribution only occurs if a generation condition is fulfilled when a gathered additional vehicle item of information that relates to a manufacturer of the additional vehicle or operation of an additional vehicle technology set up for the operation of the at least one additional vehicle lighting device by the additional vehicle, indicates that the manufacturer of the additional vehicle is comprised in a predefined list of manufacturers and/or if the additional vehicle technology has a predefined minimum standard, and/or
wherein the control device is configured such a that the determination of the overall illumination pattern and the change of the motor vehicle light distribution and/or the additional vehicle light distribution only occurs if a release condition is fulfilled when there exists a release signal generated by an occupant of the motor vehicle by way of at least one interface with the occupant of the motor vehicle, and/or
the control device is configured such that the determination of the overall illumination pattern and the change in the motor vehicle light distribution and/or the additional vehicle light distribution occurs as a function of additional vehicle driving operation item of information that relates to a position or a speed or an acceleration or an intended driving direction of the additional vehicle, and as a function of a gathered motor vehicle driving operation item of information that relates to a position or a speed or an acceleration or a steering angle or navigation item of information or a gear lever position or an intended driving direction or a surrounding area brightness, wherein the control device is configured such that the determination of the overall illumination pattern and change of the motor vehicle light distribution and/or the additional vehicle light distribution only occurs if an initiation condition is fulfilled when determined or gathered relative position information relating to a relative position between the at least one additional vehicle and the motor vehicle indicates that generation of the overall illumination pattern is possible.
